(19) United States
(12) Patent Application Publication
(10) Pub. No.: US 2025/0171617 A1
(43) Pub. Date: May 29, 2025

(54) MOLDED ARTICLE

(71) Applicant: Dow Global Technologies LLC, Midland, MI (US)

(72) Inventors: Tao Wang, Shanghai (CN); Hongyu Chen, Shanghai (CN); Xilun Weng, Shanghai (CN); Xuejun Liu, Shanghai (CN); Wenke Miao, Shanghai (CN); Wuye Ouyang, Shanghai (CN)

(21) Appl. No.: 18/838,681

(22) PCT Filed: May 5, 2022
(86) PCT No.: PCT/CN2022/090899

§ 371 Date: Aug. 15, 2024

(51) Int. Cl. C08K 5/20; C08J 3/22; C08L 23/0876

(52) U.S. Cl. CPC C08K 5/20; C08J 3/22; C08L 23/0876; C08J 2323/08; C08L 2201/08; C08L 2310/00

(57) ABSTRACT

A molded article having improved heat resistance, the molded article manufactured from a blend composition including: (a) greater than or equal to 90 percent by weight of at least one partially neutralized ethylene (meth)acrylic acid copolymer or ionomer; wherein the acid content of the partially neutralized ethylene (meth)acrylic acid copolymer is from 5 weight percent acid to 30 weight percent acid; and/or wherein the neutralization level of the ionomer is greater than or equal to 10 percent by weight; and (b) greater than or equal to 1 percent by weight of at least one bisamide having the following general chemical structure: (I) wherein R₁ and R₂ are independently selected from saturated alkyl groups having from C1 to C30 carbon atoms; wherein R₃ and R₄ are independently selected from hydrogen or an alkyl group having from C1 to C4 carbon atoms; wherein the molded article of the present invention exhibits a percent improvement in VICAT softening point, as compared to a molded article made with an ionomer without a bisamide additive, of at least 3 percent, and wherein the molded article of the present invention exhibits a percent difference in haze, as compared to a molded article made with an ionomer without a bisamide additive, of less than or equal to 15 percent.

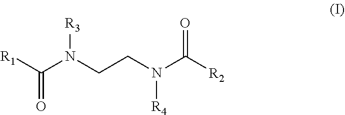

### FIELD

The present invention relates to a molded article having improved heat resistance; and more specifically to a molded article manufactured from a blend composition of: (a) a partially neutralized ethylene (meth)acrylic acid copolymer; and (b) a bisamide additive wherein the resulting molded article made from the blend composition exhibits a percent improvement in properties such as VICAT softening point, as compared to a resulting molded article made from the blend composition including a partially neutralized ethylene (meth)acrylic acid copolymer without the bisamide additive.

### BACKGROUND

Partially neutralized ethylene (meth)acrylic acid copolymers are known ionomers. These types of ionomers have several advantageous properties, including for example, clarity, scratch resistance, oil resistance, high hot tack over a broad range, stiffness, thermoformability, puncture resistance and seal through contamination. These types of ionomers are used for a variety of high-end applications such as premium perfume bottle caps, golf ball covers, packaging film sealant layers, shrink and skin packaging, bowling pin shells, protective capping layers for wood plastic composites, and laminating layers for architectural laminated glass, and the like. In spite of having good properties, many ionomers have poor heat resistance due to the ionomers' low melt temperature of small semi crystals and ionic hopping of ionic clusters. Creep and dimensional change at elevated temperatures are examples of two phenomena which limit the use of ionomers in a wider scope of applications. Improving the heat resistance of ionomers is desired to unlock new applications such as cell phone protection case, eyewear, footwear transparent cleats, building-integrated photovoltaics encapsulant, houseware/kitchenware, and the like. For example, in the cell phone case manufacturing industry, cell phone cases typically contain thin wall flex areas made from thermoplastic polyurethane (TPU). Compared to TPU, ionomers have several advantages including transparency, gloss, yellowing resistance and color relocation. However, one disadvantageous issue of known ionomers relates to the ionomers' dimensional stability at elevated temperatures (e.g., >65° C.). Therefore, it is desired to improve the overall heat resistance of the ionomers to provide the capability of using the ionomers in a wider scope of applications. Improvement of the overall heat resistance of the ionomers can be indicated by measuring the heat distortion temperature (HDT), VICAT softening point, creep, and dimensional stability of the ionomer. It is also desired to improve the heat resistance of the ionomers while retaining and maintaining the other advantageous properties of the ionomers such as clarity, scratch resistance, and the like.

There has been some success in improving the heat resistance of ionomers by using, for example, an annealing process; a blend of polymer resins such as high-density polyethylene (HDPE), nylon, and polypropylene (PP); and a crosslinking method. For example, WO 2021041618 mentions the use of a blend of polymer resins of: (1) an ionomer and (2) an isotactic polypropylene homopolymer (iPP) to improve the heat resistance (e.g., HDT, stiffness, creep) of an ionomer while maintaining a desired transparency. The above reference uses 1% to 40% of polyisopropylene (iPP) (or EP-iPP diblock copolymer or EP; where EP refers to a copolymer of ethylene and propylene); and from 60 wt % to 99 wt % of an ionomer such as a partially neutralized ethylene (meth)acrylic acid copolymer. The above reference makes no mention of blending additives with the ionomer to improve the heat resistance of the resulting molded article manufactured from the blend.

JP 2009291973 and JP 2009291974 mention a laminated film containing: (1) an ethylene methacrylic acid (EMAA) ionomer and (2) a slip agent. The slip agents mentioned in the above reference include, among others, N-oleylpalmitoamide and behenic acid amide which are monoamides. The above references make no mention of improving the heat resistance of the laminated film or the ionomer. However, it has been found that monoamides do not help to improve the heat resistance properties of ionomers.

U.S. Patent Application Publication No. 20090123613 mentions a multilayer packaging film or sheet which comprises at least one layer; and the layer is produced from: (1) an EMAA ionomer (a magnesium-neutralized ionomer) and (2) a polyamide, a barrier resin (e.g., ethylene vinyl alcohol copolymers [EVOH]), a polyolefin, a vinyl ester (e.g., ethylene-vinyl acetate [EVA]) or combinations of two or more thereof. Some of the specific polyamides mentioned in the above reference include various nylons. The blend composition mentioned in the above reference is related to magnesium-neutralized ionomer blended with other polymer resins including polyamide, EVOH, EVA, and polyolefins. The above reference makes no mention of additives blended with the ionomer to improve the heat resistance of the resulting molded article manufactured from the blend composition. Instead, the purpose described in the above reference is directed to improving the stiffness and rigidity of ionomers containing a high level of softening comonomer.

As illustrated by the above references, improving the heat resistance of ionomers has been a challenge to achieve by the industry. For example, previous efforts to improve the heat resistance of ionomers were found to compromise at least one or more desired performance properties of the ionomers such as clarity, processability, and productivity. It would be beneficial to the industry to provide ionomers with some improvement to at least one or more of the properties of ionomers at elevated temperatures. For example, improving an ionomer's dimensional stability at elevated temperatures (e.g., 65° C. or greater) while retaining the ionomer's clarity and flowability could enable the use of ionomers in applications such as the manufacture of cell phone cases and eyewear (e.g., sunglasses). Also, improving the creep resistance property at 70° C. of ionomers, without compromising the clarity property of the ionomers, could help decrease the return rate of unacceptable products such as perfume caps by the consumer. Therefore, it is desired to provide an ionomer blend composition for use in manufacturing a molded article having improved heat resistance while maintaining other beneficial properties of the ionomer such as clarity, scratch resistance, and the like.

### SUMMARY

In one embodiment, the present invention is directed to a molded article manufactured from a composition including a blend composition of: (a) at least one partially neutralized ethylene (meth)acrylic acid copolymer; and (b) at least one bisamide additive wherein the blend composition is useful for manufacturing the molded article exhibiting a percent improvement in heat resistance. In another embodiment, the acid content of the partially neutralized ethylene (meth)acrylic acid copolymer (ionomer) is from 5 weight percent acid to 30 weight percent acid. In still another embodiment, the neutralization level of the ionomer is greater than or equal to 10 percent by weight.

In yet another embodiment, the present invention is directed to a process for manufacturing a molded article having improved heat resistance, including the steps of:

(I) weighing the following components to form a mixture:
(a) at least one partially neutralized ethylene (meth)acrylic acid copolymer; wherein the acid content of the partially neutralized ethylene (meth)acrylic acid copolymer is from 5 weight percent acid to 30 weight percent acid; and
(b) at least one bisamide;

(II) melt-mixing or melt-compounding the components of step (I) at a predetermined temperature and for a predetermined period of time to form a melt blend composition; and

(III) molding the resultant melt blend composition from step (II) into a molded shape through compression molding or injection molding.

In one preferred embodiment, the at least one bisamide has the following general chemical Structure (I):

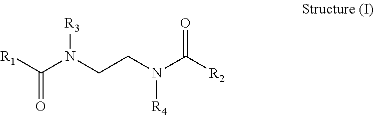

wherein R₁ and R₂ are independently selected from saturated alkyl groups having from C1 to C30 carbon atoms; and wherein R₃ and R₄ are independently selected from hydrogen or an alkyl group having from C1 to C4 carbon atoms.

### DETAILED DESCRIPTION

Temperatures used herein are in degrees Celsius (° C.).

Unless otherwise specified, “room temperature (RT)” and “ambient temperature” herein means a temperature between 20° C. and 26° C.

The term “composition,” as used herein, refers to a mixture of materials which comprises the composition, as well as reaction products and decomposition products formed from the materials of the composition.

The term “polymer” refers to a polymeric compound prepared by polymerizing monomers, whether of a same or a different type. The generic term polymer thus embraces the term “homopolymer,” which usually refers to a polymer prepared from only one type of monomer.

A “copolymer” herein means a polymer prepared from two or more monomers.

A “dipolymer” is a copolymer with two monomers.

A “terpolymers” is a copolymer with three monomers.

With reference to the above terms of copolymer, dipolymer, and terpolymer, a copolymer may be described herein with reference to its constituent comonomers or to the amounts of its constituent comonomers; for example, a copolymer may be referred to as “a copolymer comprising ethylene and 18 weight percent of acrylic acid”, or a similar description.

An “ionomer” herein, means an ionic, partially neutralized derivative of a precursor acid copolymer. “Ionomer” is used herein interchangeably with “partially neutralized ethylene (meth)acrylic acid copolymer”. The ionomer may be produced by neutralizing the unsaturated acid groups of the precursor acid copolymer with a reactant that is a source of metal ions in an amount such that neutralization of a certain percentage of the acid groups in the precursor takes place, based on the content of the total acid groups of the precursor acid copolymer. The “ionomer” or the “partially neutralized ethylene acid copolymer” may include, for example, an ionomer wherein the acid groups of the ionomer is a “(meth)acrylic acid; and the term “(meth)acrylic acid copolymer herein means an acrylic acid, a methacrylic acid or mixtures thereof.

Neutralization of, for example, carboxylic acid groups of a precursor acid copolymer may be accomplished by treating the precursor acid copolymer with a base, such as sodium hydroxide, potassium hydroxide, zinc oxide, and the like. By “partially neutralized”, for example of an ethylene (meth)acrylic acid precursor copolymer herein, means the neutralization percentage, of the carboxylic acid group of the precursor ethylene (meth)acrylic acid copolymer, is <100 percent stoichiometrically. For example, ionomers useful in the present invention include those available from The Dow Chemical Company under the tradename SURLYN™.

The term “crystalline” refers to a polymer or a polymer block that possesses a first order transition or crystalline melting point (Tm) as determined by differential scanning calorimetry (DSC) or equivalent technique. The term “crystalline” may be used interchangeably with the term “semicrystalline”.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like.).

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; ≥” means “greater than or equal to”; “@” means “at”; ppm=parts per million; ppb=parts per billion; ppt=parts per trillion; BV/hr=bed volume/hour(s); “MT”=metric ton(s); g=gram(s); mg=milligram(s); Kg=kilogram(s); L=liters; g/L=gram(s) per liter; μL=microliter(s); “g/cm³” or “g/cc”=gram(s) per cubic centimeter; g/10 min=gram(s) per 10 minutes; mg/mL=milligrams per milliliter; “kg/m³=kilogram(s) per cubic meter; ppm=parts per million by weight; pbw=parts by weight; rpm=revolutions per minute; m=meter(s); mm=millimeter(s); cm=centimeter(s); um=micron(s) or micrometer(s); nm=nanometer(s); min=minute(s); s=second(s); ms=millisecond(s); hr=hour(s); Pa=pascals; MPa=megapascals; Pa-s=Pascal second(s); mPa-s=millipascal second(s); g/mol=gram(s) per mole(s); g/eq=gram(s) per equivalent(s); Mₙ=number average molecular weight; M_{w}=weight average molecular weight; pts=part(s) by weight; 1/s or sec⁻¹=reciprocal second(s) [s⁻¹]; ° C.=degree(s) Celsius; ° C./min=degree(s) Celsius per minute; psi=pounds per square inch; kPa=kilopascal(s); %=percent; vol %=volume percent; mol %=mole percent; and wt %=weight percent.

Specific embodiments of the present invention are described herein below. These embodiments are provided so that this disclosure is thorough and complete; and fully conveys the scope of the subject matter of the present invention to those skilled in the art.

Unless stated to the contrary, implicit from the context, or customary in the art, all percentages, parts, ratios, and the like amounts are based on weight, all temperatures are in ° C., and all test methods are current as of the filing date of this disclosure.

Generally, the molded article having improved heat resistance of the present invention is manufactured from a blend composition including: (a) at least one partially neutralized ethylene (meth)acrylic acid copolymer (ionomer); wherein the acid content of the ionomer is from 5 weight percent acid to 30 weight percent acid and/or wherein the neutralization level of the ionomer is greater than or equal to 10 percent by weight; and (b) at least one bisamide wherein the molded article exhibits a percent improvement in properties, particularly an improvement in heat resistance. Other optional additives or agents, or compounds, optional component (c), can be added to the above components (a) and (b) composition, if desired, provided the optional component does not deleteriously affect the properties to be improved of the final blend composition such as heat resistance or other beneficial properties.

Component (a) of the blend formulation or composition for preparing the molded article of the present invention is at least one partially neutralized ethylene (meth)acrylic acid copolymer or ionomer; wherein the ionomer is subjected to sodium ion (Na⁺) neutralization, zinc ion (Zn²⁺) neutralization or other neutralization ions such as calcium ion (Ca²⁺), lithium ion (Li⁺), aluminum ion (Al³⁺), scandium ion (Sc³⁺), iron ion (such as Fe²⁺ and Fe³⁺), yttrium ion (Y³⁺), titanium ion (Ti⁴⁺), zirconium ion (Zr⁴⁺), hafnium ion (Hf⁴⁺), vanadium ion (such as V²⁺, V³⁺, V⁴⁺ and V⁵⁺), cerium ion (such as Ce³⁺ and Ce⁴⁺), and magnesium ion (Mg²⁺); and mixtures thereof to form an ionomer. The ionomer of the present invention may be prepared by standard neutralization techniques known in the art.

In some embodiments, the total neutralization of the ionomer can be from at least ≥1% up to 100%. In a preferred embodiment, the ionomer is partially neutralized. By “partially neutralized” it is meant that the neutralization of the ionomer is, for example, at least ≥1% to 90%. In other embodiments, the total percent neutralization of the ionomer is from 5% to 90% in one embodiment, from 10% to 70% in another embodiment, and from 20% to 65% in still another embodiment. It is known that neutralization levels of the ionomer lower than 1% can provide less ionomer character; and that neutralization levels of the ionomer higher than 90% can produce lower flow ionomers. The metal ions used may be any metal ion of group I or group II of the periodic table of chemical elements. In some preferred embodiments, the metal ions are sodium, zinc, lithium, magnesium, calcium or a mixture of any of these metal ions. In one preferred embodiment, sodium, zinc, lithium, magnesium, and mixtures thereof are used.

In some embodiments, the ionomer useful in the present invention has an ethylene (meth)acrylic acid content of at least ≥80 wt %; and a melt index (MI, tested at 190° C. and 2.16 kg) of at least ≥0.1 g/10 min. For example, in some embodiments, the ionomer of the present invention has an ethylene(meth)acrylic acid content of from 80 wt % to 99 wt % in one general embodiment, from 85 wt % to 99 wt % in another embodiment, and from 90 wt % to 99 wt % in still another embodiment.

In some embodiments, the resulting ionomer used to make the blend compositions useful in the present invention may have a MI of from 0.01 grams/10 minutes (g/10 min) to 100 g/10 min in one general embodiment, from 0.1 g/10 min to 50.0 g/10 min in another embodiment, from 0.1 g/10 min to 30 g/10 min in still another embodiment. The MI of the ionomer can be determined by the procedure described in ASTM D123 8 (at 190° C. and 2.16 Kg).

In other embodiments, some of the other advantageous properties of the ionomer include for example an appropriate VICAT Softening Point as determined by the method described in ASTM D1525 at a temperature rising rate of 50° C./hr; an appropriate heat distortion temperature (HDT) as determined by the method described in ASTM D648 at a temperature rising rate of 120° C./hr; an appropriate transparency and haze as determined by the method described in ASTM D1003 Procedure A; and an appropriate creep resistance and dimensional stability as determined, in the present invention, by the following methods:

### Creep Resistance Test

Samples are stored in a drier box (at 25% humidity and room temperature, ˜24° C.) for 3 weeks before testing the samples. The samples are cut to a size of 40 mm×12.7 mm×2 mm. The creep resistance test is carried out through a rheometer (ARES-G2, available from TA instruments) in torsion mode. The sample length between two torsion fixtures is 30 mm. The test characteristics of the samples include: a temperature of 70° C.; an angular frequency of 10 rad/s; a strain of 0.01% to ˜1%; a creep of 0.6 MPa, 7,200 s; and a recovery of zero Pa, 7,200 s.

### Dimensional Stability Test

Specimens of ionomers are stored in a drier box (at 25% humidity and room temperature, ˜24° C.) for 3 weeks before testing the specimens. The specimens are a size of 120 mm×10 mm×4 mm. The original length of the specimens (defined as L0) is measured using vernier calipers before heating the specimens. Then the ionomer specimens are heated in an oven at an elevated temperature (e.g., at 60° C. or at 70° C.) for one period of 3 days and for another period of 7 days. The length of each of the specimens is then re-measured at 3 days and 7 days (defined as “L_{after heat}”); and the “Change %” for each of the specimens is calculated using the following formula: Change %=(L_{after heat}−L0)/L0 which is Formula (IV) in the Examples. Other methods known to skilled in the art can be used to determine the above properties of the ionomers if desired.

Exemplary of ethylene (meth)acrylic acid copolymers or ionomers useful in the present invention include ethylene methacrylic acid (EMAA), ethylene acrylic acid (EAA), and mixtures thereof. In some preferred embodiments, the ionomer used in the present invention may be partially neutralized. The ionomer of the present invention can include various grades of ionomers having different ranges of neutralization. For example, the ionomer may include a (meth)acrylic acid content of from 5 wt % acid to 30 wt % acid in one general embodiment, from 8 wt % to 28 wt % in another embodiment, from 9 wt % acid to 25 wt % acid in still another embodiment, and from 10 wt % acid to 20 wt % acid in yet another embodiment. And, the ionomer may have a neutralization level in the range of from 1% to 100% in one general embodiment, from 1% to 90% in another embodiment, from 5% to 90% in still another embodiment, from 10% to 70% in yet another embodiment, and from 20% to 70% in even still another embodiment, and from 20% to 65% in even yet another embodiment. Also, the acid may be neutralized with a Na+ ion or a Zn+ ion. Accordingly, the ionomer used in the present invention may be selected from the group consisting of, for example: an ionomer having 15 wt % acid and which is 50% neutralized with a Na⁺ ion; an ionomer having 10 wt % acid and which is 55% neutralized with a Na⁺ ion; an ionomer having 15 wt % acid and which is 59% neutralized with a Na⁺; an ionomer having 15 wt % acid and which is 58% neutralized with a Zn²⁺; an ionomer having 19 wt % acid and which is 45% neutralized with a Na⁺ ion; and mixtures thereof.

In another embodiment, the ionomer used in the present invention to form the blend composition, can include a mixture of: (1) ethylene (meth) acrylic acid copolymers with different ranges of neutralization and (2) ethylene (meth) acrylic acid copolymers without neutralization. The neutralization level of the ionomer present in the blend composition means the average neutralization percentage of the carboxylic acid group of the precursor ethylene (meth)acrylic acid copolymers mixture stoichiometrically.

In one general embodiment, the concentration of the ionomer, useful for preparing the blend composition, can be ≥80 wt % to 99 wt %, based on the total weight of all components in the composition ≥85 wt % to 98 wt % in another embodiment, and ≥90 wt % to 98.5 wt % in still another embodiment. If the concentration of the ionomer is above 99 wt %, the ionomer can exhibit a low percent improvement on heat resistance; and if the concentration of the ionomer is below 80 wt %, the clarity of the ionomer can be detrimentally affected.

Component (b) of the blend composition useful for preparing the molded article of the present invention, is at least one bisamide additive. In one general embodiment, the bisamide additive can be at least one bisamide having the following general chemical structure, Structure (I):

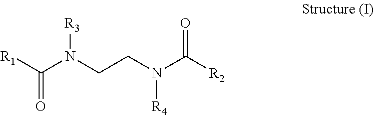

wherein R₁ and R₂ are independently selected from saturated alkyl groups having from C1 to C30 carbon atoms; and

wherein R₃ and R₄ are independently selected from hydrogen or an alkyl group having from C1 to C4 carbon atoms.

Exemplary of the bisamide, component (b), includes ethylenebisstearamide (EBS), ethylenebislauramide (EBL), ethylenebisbehenamide (EBB), ethylenebisdecoylamide (EBD), ethylenebispelargonamide (EBP), ethylenebiscapramide (EBC), ethylenebisundecanoic amide (EBU), and mixtures thereof. In one preferred embodiment, the bisamide of the blend composition of the present invention comprises, consists essentially of, or consists of: EBS, EBD, EBL, and mixtures thereof.

In some embodiments, the properties of the bisamide additive include for example, a melting point above 130° C. as determined by differential scanning calorimeter (DSC).

The concentration of the bisamide additive useful in preparing the blend composition of the present invention can be from 0.5 wt % to 15 wt %, based on the total weight of all components in the composition, in one general embodiment, from 1 wt % to 15 wt % in another embodiment, and from 2 wt % to 10 wt % in still another embodiment.

In addition to components (a) and (b) above, the blend composition of the present invention may optionally be formulated with a wide variety of additives to enable performance of specific functions while maintaining the excellent benefits/properties of the present invention blend composition for making a molded article having an improved heat resistance property. For example, the optional additives, component (c), useful in the blend composition may be selected from the group consisting of colorants, pigments, carbon black, mineral fillers, process oils; flame retardants, foaming agents; process aids, antioxidants, UV light stabilizers, scorch retardant additives, metal oxide, nucleating agents, and mixtures thereof. The additives can be compounded either in the original form or in the form of a masterbatch.

In other embodiments, the optional additives added to the blend composition can include one or more polymeric components of polypropylene, polyethylene, thermoplastic vulcanizates, ethylene propylene diene monomer, non-neutralized ethylene (meth)acrylic acid copolymer, ethylene acrylate copolymer (where the alkyl acrylate comprises methyl acrylate, methacrylate, ethyl acrylate, or n-butyl acrylate, or isobutyl acrylate), and mixtures thereof.

The optional compounds, when used in preparing the blend composition useful in the present invention, can be present in an amount generally in the range of from 0 wt % to 20 wt % in one embodiment; from 0.01 wt % to 20 wt % in another embodiment; and from 0.1 wt % to 20 wt % in still another embodiment.

In one broad embodiment, the process for making a blend composition or formulation useful for manufacturing a molded article of the present invention includes mixing, admixing, or blending: (a) at least one ionomer; and (b) at least one bisamide having the following general chemical structure, Structure (I):

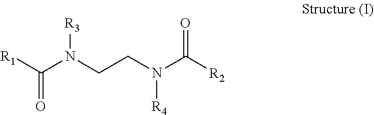

wherein R₁ and R₂ are independently selected from saturated alkyl groups having from C1 to C30 carbon atoms; and

wherein R₃ and R₄ are independently selected from hydrogen or an alkyl group having from C1 to C4 carbon atoms.

The above mixture of components (a) and (b) can include one or more additional optional components, component (c), if desired. For example, the components (a), (b), and optionally (c) can be mixed together in the desired concentrations discussed above. If desired, the optional additives, component (c), can be mixed with any one of the components (a) and (b) or both components (a) and (b). The order of mixing of the components is not critical; and two or more components can be mixed together followed by addition of the remaining components. The formulation components may be mixed together by any conventional mixing process and equipment as known to those skilled in the art of mixing such as a twin-screw extruder. For example, when a twin-screw extruder is used, the components can be mixed at a temperature of the various zones of the extruder barrel at a temperature of from 115° C. to 190° C. in one general embodiment. Other characteristics of the twin screw extruder used are known to those skilled in the art, such as, the power of the extruder; the diameter, D, of the extruder; the length/diameter, L/D, ratio of the extruder; the temperatures of the various zones of the extruder barrel; the screw speed; and the total feeding rate of the components.

As an illustration of the present invention and not to be limited thereto, in one preferred embodiment, the temperatures of the various zones (e.g., 6 zones) of the extruder barrel can be as follows: 115° C./145° C./190° C./190° C./190° C./180° C.; the screw speed of the extruder can be set at 250 rpm, and the total feeding rate of the components to the extruder can be carried out at 10 kg/hr.

The blend composition comprising the ionomer and bisamide of present invention produced by the methods described above, has several advantageous properties and/or benefits compared to known elastomeric compositions. For example, the blend composition of the present invention, when used to manufacture a molded article, can provide a molded article which exhibits a percent improvement in HDT at elevated temperatures (as measured by

VICAT softening point (at 50° C./hr 10 N)), as compared to a molded article made from a composition including an ionomer without a bisamide additive. Generally, the HDT (at 120° C./hr, 0.45 MPa) of the molded article, as measured by the VICAT softening point, can be increased by at least 3% in one embodiment, at least 5% in another embodiment, from 5% to 50% in still another embodiment and from 5% to 30% in yet another embodiment. In addition, the molded article made from the composition of the present invention, while exhibiting an improved heat resistance, maintains (retains) other advantageous properties such as good dimensional stability, low creep, good stiffness, low haze, clarity, scratch resistance, and the like.

In some embodiments, the % transparency (% trans) of the ionomer is at least 80% in one general embodiment, from 80% to 99% in another embodiment and from 80% to 95% in still another embodiment. In some embodiments, the % haze of the ionomer is from 1% to 25% in one general embodiment, from 1% to 20% in another embodiment and from 1% to 15% in still another embodiment.

The blend composition of the present invention can be used, for example, to fabricate various profiles, parts, products, or articles utilizing a molding process. Other applications for the blend composition and articles made therefrom include appliance applications, electronic product applications, protection cases applications, houseware/kitchenware applications, sports good applications, footwear and package applications, and the like.

For example, in a broad embodiment, the process for manufacturing a molded article includes the steps of first making the blend composition useful in the present invention and then using the blend composition to manufacture a molded article. In some embodiments, the process of manufacturing a molded article includes the steps of:

(I) weighing the following components: (a) the at least one partially neutralized ethylene (meth)acrylic acid copolymer described above; (b) the at least one bisamide described above, and optionally (c) additional additives, if desired, to provide the proper amounts of components (a), (b) and optionally (c);

(II) melt-mixing or melt-compounding the components of step (I) to form a mixture or blend composition; and

(III) molding the resultant mixture or blend composition from step (II) into a molded shape through compression molding or injection molding.

In other embodiments, the process of manufacturing a molded article includes the steps of:

(I) weighing the following components: (a) the at least one partially neutralized ethylene (meth)acrylic acid copolymer described above; (b) the at least one bisamide described above, and optionally (c) additional additives, if desired, to provide the proper amounts of components (a), (b) and optionally (c);

(II) mixing or compounding the components of step (I) at a predetermined temperature and for a predetermined period of time to form a mixture or blend composition;

(III) forming the resultant mixture composition from step (II) into a shape of finished part or article; wherein the forming the shaped part or article is carried out in a mold apparatus such as by using a compression molding or injection molding apparatus and method;

(IV) cooling, or allowing to cool, the shaped finished part or article from step (III) in the mold apparatus to a sufficient temperature to form a solid handleable finished solid part or article; and

(V) removing the finished solid part or article of step (III) from the mold apparatus.

In some embodiments of the above process, the process condition(s) for carrying out the compounding step of step (II) of the above process include melt temperatures in the range of from 140° C. to 280° C. in one embodiment and from 140° C. to 260° C. in another embodiment.

The compression molding and injection molding apparatus and methods are known to those skilled in the art of molding. For example, in one general embodiment, the conditions for carrying out the injection molding of the finished part or article of step (III), i.e., the step of forming the resultant mixture composition from step (II) into a shape of a finished part or article, includes, for example, the following steps: (1) the mixture composition is melted at a processing temperature of from 160° C. to 250° C. to form a molten composition; and then (2) the molten composition is injected into a cooler mold and held a pressure of from 20 MPa to 200 MPa for a period of time (packing time). The packing time of the molten polymer composition is of from 1 s to 30 s; and the mold temperature is from 10° C. to 50° C. Thereafter, (3) the resulting molded article is removed from the mold.

The above non-limiting processing temperature range for injection molding may vary depending on various parameters such as the particular ionomer selected, the part specifications, and the mold conditions (e.g., the thickness and size of a part; and the mold gate size and position and the like). For example, when an ionomer having a high MI (e.g., ≥3 g/10 min) is used and a thick (e.g., ≥4 mm) part is desired to be manufactured, a low processing temperature such as from 160° C. to 200° C. can be used. On the other hand, when an ionomer having a low MI (e.g., <3 g/10 min) is used and a thin (e.g., <4 mm) part is desired to be manufactured, a high processing temperature such as from 200° C. to 250° C. can be used.

In another general embodiment, compression molding is carried out by (1) placing pellets of the polymer composition in a mold, (2) inserting the mold into a hot press and (3) holding the mold under pressure for a period of time at a melting temperature of from 160° C. to 250° C. Subsequently, (4) the mold is cooled to remove the resultant molded article from the mold.

For compression molding, a pre-set melting temperature to melt the polymer resin is generally set at 20° C. higher than the actual melting temperature of the polymer resin; and the processing temperature can be in the range of from 100° C. to 250° C. depending on the resins. For compression molding, the above non-limiting processing temperature range may also vary depending on various parameters such as the particular ionomer selected, the part specifications, and the mold conditions (e.g., the thickness and size of a part; and the mold gate size and position and the like).

In some embodiments, the ionomer, component (a), can be present in the blend composition at a concentration of from 80 wt % to 99 wt % to form the mixture or blend composition. In some embodiments, component (a) can have a (meth)acrylic acid content of from 5 wt % to 50 wt %; and component (a) can have a melt index of from 0.01 g/10 min to 100 g/10 min. The bisamide additive can be present in the composition at a concentration of from ≥1 wt % to 10 wt % such as to form the mixture or blend composition.

In another general embodiment, the bisamide additive can be compounded to form a masterbatch composition using the ionomer as the carrier resin; and the concentration of the bisamide used to form the masterbatch can be, for example, from ≥1 wt % to 70 wt %. The compounding process to form the masterbatch is mixing or blending the ionomer, the bisamide, and any optional components, if desired, to form a homogeneous mixture.

### EXAMPLES

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of the compositions described herein. Unless otherwise stated all parts and percentages are by weight on a total weight basis.

### Designations

Some of the designations and abbreviations used for some of the materials and items used in the Examples are as follows:

“SA” stands for stearamide which is a monoamide additive and commercially available from SCRC.

“BA” stands for behenamide which is a monoamide additive and commercially available from SCRC.

“EBS” stands for ethylenebisstearamide which is a lab sample of a bisamide additive and available from Sichuan Tianyu Oleochemical Co. Ltd.

“EBO” stands for ethylenebisoleamide which is a bisamide additive and commercially available from SCRC.

“EBB” stands for ethylenebisbehenamide which is a bisamide additive and commercially available from SCRC.

“C6-di” stands for adipic acid which is a di-acid and commercially available from SCRC.

“C12-di” stands for dodecanedioic acid which is a di-acid and commercially available from SCRC.

“HDT” stands for heat distortion temperature.

“MAA” stands for methacrylic acid.

### Raw Materials

The pertinent ionomer components (raw materials; ingredients) used in the Examples are described in Table I; and all of the ionomers are available from The Dow Chemical Company.

TABLE I
Ionomer Materials

| Component | Brief Description of Component |
|---|---|
| Ionomer1 | An ionomer (a polyethylene methacrylic acid copolymer) |
| | having 15 wt % MAA, 50% neutralized, Na⁺. |
| Ionomer2 | An ionomer (a polyethylene methacrylic acid copolymer) |
| | having 10 wt % MAA, 55% neutralized, Na⁺. |
| Ionomer3 | An ionomer (a polyethylene methacrylic acid copolymer) |
| | having 15 wt % MAA, 59% neutralized, Na⁺. |
| Ionomer4 | An ionomer (a polyethylene methacrylic acid copolymer) |
| | having 15 wt % MAA, 58% neutralized, Zn²⁺. |
| Ionomer5 | An ionomer (a polyethylene methacrylic acid copolymer) |
| | having 19 wt % MAA, 45% neutralized, Na⁺. |

### Formulations

The blend compositions used in the Examples were made based on the following formulations described in Table II:

TABLE II
Blend Formulations

| | | | Ionomer | Additive | Additive |
|---|---|---|---|---|---|
| | | | Loading | Loading | Loading |
| Example No. | Ionomer | Additive | (g) | (g) | (wt %) |
| Comp. Ex. A | Control (Ionomer1 without additive) | — | 1,000 | — | — |
| Comp. Ex. B | Ionomer1 | SA | 950 | 50 | 5 |
| Comp. Ex. C | Ionomer1 | BA | 950 | 50 | 5 |
| Comp. Ex. D | Ionomer1 | EBO | 950 | 50 | 5 |
| Comp. Ex. E | Ionomer1 | C6-di | 950 | 50 | 5 |
| Comp. Ex. F | Ionomer1 | C12-di | 950 | 50 | 5 |
| Comp. Ex. G | Control (Ionomer2 without additive) | — | 1,000 | — | — |
| Comp. Ex. H | Control (Ionomer3 without additive) | — | 1,000 | — | — |
| Comp. Ex. I | Control (Ionomer4 without additive) | — | 1,000 | — | — |
| Comp. Ex. J | Control (Ionomer5 without additive) | — | 1,000 | — | — |
| Inv. Ex. 1 | Ionomer1 | EBS | 950 | 50 | 5 |
| Inv. Ex. 2 | Ionomer1 | EBB | 950 | 50 | 5 |
| Inv. Ex. 3 | Ionomer2 | EBS | 950 | 50 | 5 |
| Inv. Ex. 4 | Ionomer3 | EBS | 950 | 50 | 5 |
| Inv. Ex. 5 | Ionomer4 | EBS | 950 | 50 | 5 |
| Inv. Ex. 6 | Ionomer5 | EBS | 950 | 50 | 5 |

### General Procedure for Compounding Process

The ionomer compound was in the form of pellets and the bisamide additive was in the form of a powder. The ionomer and bisamide components were blended together in accordance with the loadings set forth in the above-described Table II via a two-screw extruder compounding process. The additive powder was fed together with the ionomer pellets at a designed weight ratio of for example, 1:19 (which designates a 5 wt % loading), into the extruder under the extruder conditions as follows:

The extruder instrument was a ZSK18 twin screw extruder having a power of 19.2 KW, a diameter (D) of 18 mm, and a L/D of 48. The temperature of the various zones of the extruder barrel were set as 115° C./145° C./190° C./190° C./190° C./180° C., the screw speed was set at 250 rpm, and the total feeding rate of the components was carried out at 10 kg/hr.

### General Procedure for Injection Process

The ionomer pellets were dried in a dehumidifier for at least 4 hr at 60° C. before feeding the pellets to the extruder for injection molding. The injection molding equipment used in this process is referred to as Fanuc Roboshot S-2000i100BH injection machine available from FANUC Corporation which was used for injection molding to make a specimen for impact testing. The barrel temperature for the injection screw was set to 190° C., with a cooling temperature of 20° C. and a cooling time of 15 s. The injection rate was set at 30 mm/s, and the injection pressure was 200 MPa. Two different sizes of specimen samples for testing were produced: (1) rectangular bar samples having the following dimensions of length (L)×width (W)×thickness (T): 120 mm×10 mm×4 mm, where the samples are used for VICAT testing and dimensional stability testing; and (2) rectangular bar samples having the following dimensions of L×W×T: 60 mm×60 mm×2 mm, where the samples are used for creep resistance testing. The samples used for the creep resistance testing were further cut to specimens having a size of 40 mm×12.7 mm×2 mm for the creep resistance testing.

### Testing Methods

### VICAT Softening Point

The samples for testing (test specimens) were stored in a drier box (at 25% relative humidity [RH] and room temperature [RT; ˜24° C.]) for 3 weeks before testing. The test specimens were cut to a size of 10 mm×10 mm×4 mm for testing. The VICAT softening point of the test specimens was determined on the test instrument, Ceast HDT. 6. VICAT, available from Instron Corporation. A flat-ended needle loaded with a specified mass is placed in direct contact with a test specimen. The mass applied is 10 N loads. The test specimen and needle are heated at a rate of 50° C./hr in a heat-transfer medium. The temperature at which the needle has penetrated to a depth of 1 mm is recorded as the VICAT softening point. The VICAT softening point test method use in the present invention is described in ASTM D1525. The results are described in Table III.

### HDT

The samples were stored in a drier box (at 25% RH and RT) for 3 weeks before test. The sample size was 120 mm×10 mm×4 mm obtained from the above-described injection molding process. The samples were tested on an instrument referred to as Ceast HDT 6 VICAT available from Instron Corporation, to obtain the HDT property of the samples. A bar of rectangular cross section is tested in the edgewise position as a simple beam with the load applied at the bar's center to give maximum fiber stresses of 0.455 MPa [66 psi]. The specimen is immersed under load in a heat-transfer medium provided with a means of raising the temperature at 2° C./min. The temperature of the medium is measured when the test bar has deflected 0.34 mm [0.010 inch]. This temperature is recorded as the deflection temperature under flexural load of the test specimen. The method used to determine the HDT of the samples is described in ASTM D648. The results are described in Table III.

### Transparency and Haze

The test methods used for obtaining the transparency and haze properties of the samples were carried out on the instrument referred to as BYK Gardner haze-guard dual equipment available from BYK Instruments of Altana Group Corporation. The sample size for testing was 60 mm×60 mm×2 mm which was obtained from the injection molding general procedure described above. The method used to determine the transparency and haze of the samples is described in ASTM D1003 Procedure A. The results are described in Table III.

The above-described testing experiment includes two parts: a light source part and a light trap part. A specimen is placed in the middle of the two parts and the results from the testing are recorded. Light intensity is collected and is used for calculating the transmittance and haze. The general procedure includes the steps of: (1) measuring the background in air as 0% haze or 100% transmittance; (2) calibrating the testing equipment (detector) by placing a black cover over the test window of the detector to block out light to the detector and then measuring transmittance and haze, wherein the measurement results in 0% transmittance (or 100% haze); and then (3) placing the sample in the middle between the aforementioned two parts to obtain the test results.

### Melt Index

Melt Index (MI), described in Table III, is tested using the procedure described in ASTM D-1238 at the following conditions: 190° C., using a 2.16 Kg weight.

TABLE III
Test Results

| | | | Additive | VICAT | | | HDT | MI |
|---|---|---|---|---|---|---|---|---|
| Example | | | Loading | (50° C./hr | Trans⁽¹⁾ | Haze | (120° C./hr, | (g/10 |
| No. | Ionomer | Additive | (%) | 10N) | (%) | (%) | 0.45 MPa) | min) |
| Comp. | Control | — | — | 57.4 | 92.4 | 4.77 | 37.0 | 5.2 |
| Ex. A | (Ionomer1 | | | | | | | |
| | without | | | | | | | |
| | additive) | | | | | | | |
| Comp. | Ionomer1 | SA | 5 | 56.5 | | | 32.0 | 12.9 |
| Ex. B | | | | | | | | |
| Comp. | Ionomer 1 | BA | 5 | 59.2 | | | 38.2 | 14.3 |
| Ex. C | | | | | | | | |
| Comp. | Ionomer 1 | EBO | 5 | 60.4 | 90.6 | 10.0 | 36.3 | 11.3 |
| Ex. D | | | | | | | | |
| Comp. | Ionomer 1 | Adipic acid | 5 | 60.8 | 74.7 | 77.0 | 41.1 | 19.9 |
| Ex. E | | (C6-di) | | | | | | |
| Comp. | Ionomer 1 | Dodecaned | 5 | 61.4 | 71.5 | 32.3 | 38.0 | 41.5 |
| Ex. F | | ioic acid | | | | | | |
| | | (C12-di) | | | | | | |
| Comp. | Ionomer2 | — | — | 71.8 | 89.8 | 10.3 | 37.8 | NT⁽²⁾ |
| Ex. G | | | | | | | | |
| Comp. | Ionomer3 | — | — | 58.0 | 92.3 | 8.29 | 38.1 | NT |
| Ex. H | | | | | | | | |
| Comp. | Ionomer4 | — | — | 57.4 | 90.7 | 11.5 | 39.6 | 3.0 |
| Ex. I | | | | | | | | |
| Comp. | Ionomer5 | — | — | 49.2 | 92.7 | 5.53 | 39.4 | 5.3 |
| Ex. J | | | | | | | | |
| Inv. Ex. 1 | Ionomer 1 | EBS | 5 | 63.2 | 91.9 | 8.80 | 39.0 | 8.7 |
| (% Δ) | | | | (+10.1%) | | (+4.03) | | |
| Inv. Ex. 2 | Ionomer 1 | EBB | 5 | 61.6 | 90.6 | 13.0 | 37.0 | 8.6 |
| (% Δ) | | | | (+7.3%) | | (+8.23) | | |
| Inv. Ex. 3 | Ionomer2 | EBS | 5 | 81.0 | 85.4 | 23.0 | 38.8 | — |
| (% Δ) | | | | (+12.8%) | | (+12.7) | | |
| Inv. Ex. 4 | Ionomer3 | EBS | 5 | 70.8 | 92.2 | 6.65 | 37.5 | — |
| (% Δ) | | | | (+19.3%) | | (−1.64) | | |
| Inv. Ex. 5 | Ionomer4 | EBS | 5 | 64.8 | 90.1 | 8.04 | 41.3 | 4.4 |
| (% Δ) | | | | (+12.9%) | | (−3.46) | | |
| Inv. Ex. 6 | Ionomer5 | EBS | 5 | 52.7 | 92.5 | 10.7 | 37.3 | 13.5 |
| (% Δ) | | | | (+7.1%) | | (+5.17) | | |

Notes for Table III:
⁽¹⁾“Trans” = transparency.

To calculate the “%Δ” for the VICAT value described in the above Table III, the following Formula (I) is used:

$$\% Δ = \frac{{VICAT}_{Inv . Ex} - {VICAT}_{Comp . Ex}}{{VICAT}_{Comp . Ex}} \times 100 \% \qquad Formula ( I )$$

To arrive at the %Δ VICAT value using Formula (I), Inv. Ex. 1 is compared to Comp. Ex. A; Inv. Ex. 2 is compared to Comp. Ex. A; Inv. Ex. 3 is compared to Comp. Ex. G; Inv. Ex. 4 is compared to Comp. Ex. H; Inv. Ex. 5 is compared to Comp. Ex. I; and Inv. Ex. 6 is compared to Comp. Ex. J.

To calculate the “%Δ” for the haze value described in the above Table III, the following Formula (II) is used:

$$\% Δ = {haze}_{Inv . Ex} - {haze}_{Comp . Ex} \qquad Formula ( II )$$

To arrive at the %Δ haze value using Formula (II), Inv. Ex. 1 is compared to Comp. Ex. A; Inv. Ex. 2 is compared to Comp. Ex. A; Inv. Ex. 3 is compared to Comp. Ex. G; Inv. Ex. 4 is compared to Comp. Ex. H; Inv. Ex. 5 is compared to Comp. Ex. I; and Inv. Ex. 6 is compared to Comp. Ex. J.

### Creep Resistance

Samples to be tested for creep resistance were stored in a drier box (at 25% RH and RT) for 3 weeks before testing. The samples were cut to a size of 40 mm×12.7 mm×2 mm. The sample length between two torsion fixtures was 30 mm. The creep resistance test was carried out via a rheometer referred to as ARES-G2 available from TA instruments, geometry of torsion fixture. The creep resistance testing parameters were as follows: the temperature was 70° C.; the angular frequency was 10 rad/s; the strain was 0.01% to ˜1%; and the torsion was 0.6 MPa after 7,200 s. The recovery was zero Pa at 7,200 s. The results are described in Table IV.

TABLE IV
Test Results for Strain % of Creep and Recovery at 70° C. After 7,200 s

| | | | | | Improvement | | Improvement |
|---|---|---|---|---|---|---|---|
| | | | | Strain % | percentage | Strain % | percentage |
| | | | Additive | Creep | Versus | Recovery | Versus |
| | | | Loading | (After | Control | (After | Control |
| Example No. | Ionomer | Additive | (%) | 7200 s) | (% Δ) | 7200 s) | (% Δ) |
| Comp. Ex. A | Ionomer1 | — | — | 23.4 | — | 14.6 | — |
| Comp. Ex. B | Ionomer1 | SA | 5 | 22.6 | 3.4 | 13.8 | 5.5 |
| Comp. Ex. C | Ionomer1 | BA | 5 | 23.0 | 1.7 | 15.0 | −2.7 |
| Comp. Ex. D | Ionomer1 | EBO | 5 | 23.4 | 0 | 15.0 | −2.7 |
| Comp. Ex. E | Ionomer2 | — | — | 12.2 | — | 7.6 | — |
| Comp. Ex. F | Ionomer3 | — | — | 21.6 | — | 13.8 | — |
| Comp. Ex. G | Ionomer4 | — | — | 21.0 | — | 13.1 | — |
| Comp. Ex. H | Ionomer5 | — | — | 65.6 | — | 38.4 | — |
| Inv. Ex. 1 | Ionomer1 | EBS | 5 | 18.6 | 20.5 | 11.2 | 23.3 |
| Inv. Ex. 2 | Ionomer1 | EBB | 5 | 19.0 | 18.8 | 12.0 | 17.8 |
| Inv. Ex. 3 | Ionomer2 | EBS | 5 | 9.9 | 18.9 | 5.8 | 23.7 |
| Inv. Ex. 4 | Ionomer3 | EBS | 5 | 14.4 | 33.3 | 8.4 | 39.1 |
| Inv. Ex. 5 | Ionomer4 | EBS | 5 | 19.0 | 9.5 | 12.1 | 7.6 |
| Inv. Ex. 6 | Ionomer5 | EBS | 5 | 47.0 | 28.3 | 32.0 | 16.7 |

To calculate the “%Δ” for the creep resistance value described in the above Table IV, the following Formula (III) is used:

$$\% Δ = \frac{strain {\%}_{Inv . Ex} - strain {\%}_{C omp . Ex}}{strain {\%}_{Comp . Ex}} \times 100 \% \qquad Formula ( III )$$

To arrive at the %Δ creep resistance value using Formula (III), Inv. Ex. 1 is compared to Comp. Ex. A; Inv. Ex. 2 is compared to Comp. Ex. A; Inv. Ex. 3 is compared to Comp. Ex. E; Inv. Ex. 4 is compared to Comp. Ex. F; Inv. Ex. 5 is compared to Comp. Ex. G; and Inv. Ex. 6 is compared to Comp. Ex. H.

### Dimensional Stability Test

Slips of ionomer samples were stored in a drier box (at 25% RH and RT) for 3 weeks before testing. The slips were molded via the above-described injection molding process. The slips were of a size of 120 mm×10 mm×4 mm. The original length of the slips was measured by vernier calipers before heating the slips. The ionomer samples were heated in an oven at two different elevated temperatures: 60° C. and 70° C. for 3 days and 7 days, respectively. The length of the slips was measured at 3 days and 7 days and the change percentage (Change %) of the length of the slips was calculated using the following Formula (IV):

$$Change \% = ( {L}_{after h eat} - {L}_{0} ) / {L}_{0} \qquad Formula ( IV )$$

wherein L_{after heat} is the length of the slip after heating the slip, and Lo is the original length of the slip. The results for testing Inv. Ex. 5 (Ionomer5+5% EBS) versus Comp. Ex. H (Ionomer5) are described in Table V.

TABLE V
Test Results for Dimensional Stability at Elevated Temperature

| | Comp. Ex. H | Inv. Ex. 5 |
|---|---|---|
| Change % | Ionomer5 | Ionomer5 + 5% EBS |
| Change % @ 60° C. for 3 days | 1.31% | 0.25% |
| Change % @ 60° C. for 7 days | 1.36% | 0.33% |
| Change % @ 70° C. for 3 days | 3.85% | 0.89% |
| Change % @ 70° C. for 7 days | 3.95% | 0.95% |
| Change % @ 80° C. for 3 days | 12.28% | 3.72% |
| Change % @ 80° C. for 7 days | 12.68% | 3.95% |
| Change % @ 85° C. for 3 days | 19.13% | 8.28% |
| Change % @ 85° C. for 7 days | 19.70% | 8.80% |

### Discussion of Results

VICAT softening point and HDT are two appropriate properties reflecting the property of heat resistance. The ionomers have a low VICAT softening point and HDT due to the ionomers' special structure of ionic clusters and secondary crystallites compared with other polyolefin resins. The challenge to improve the heat resistance of the ionomers without compromising other important performance properties like high transparency and low haze. In the present invention, the bisamide additive was blended with the ionomers and the VICAT softening point of the resulting blend composition was improved while the transparency and haze were maintained comparing with the original ionomers. The data shown in Table III indicates that 5 wt % EBS or EBB improves the VICAT at around 4° C. to 11° C. compared with the original ionomers.

The transparency and haze of the ionomers tested were maintained except in Ionomer3 which contains only 10% MAA. While not to be limited to any particular theory, it is theorized that the mechanism for Ionomer3 not maintaining transparency and haze is as follows: as the bisamide group forms a hydrogen bond with the carboxylic group, the crystallite size of EBS is depressed. If the MAA % of the ionomer is low, the hydrogen bond is not strong enough to bind the EBS to the carboxylic group; and any free EBS crystals grow to a larger size which, in turn, strongly scatters the light.

Two monoamides were inspected with 5 wt % loading based on the weight of all blending components. However, unlike the bisamides additives, there was no obvious change in the VICAT property. Stearamide caused a significant decrease in the HDT property although the transparency and haze remained unchanged from the original ionomers. The bisamide (EBO) containing an unsaturated alkyl chain was also inspected. Since the double bond on the alkyl chain will hurt the crystallinity of bisamide, EBO resulted in less of an improvement in VICAT softening point compared to saturated bisamide (EBS).

Poor creep resistance at elevated temperature is another shortcoming of ionomers. Results in Table IV indicate that 5 wt % EBS additives could significantly improve the creep resistance of the ionomers at 70° C. However, the monoamide (SA) nor the bisamide (EBO) having a double bond did not indicate an obvious change in the creep resistance property. The creep resistance result at 70° C. aligned with the VICAT softening point result and demonstrated the bisamide additives with saturated alkyl chain could improve the heat resistance of ionomers.

Moreover, the dimensional stability at an elevated temperature is also a concern of the ionomers. Even at 60° C. or 70° C., an obvious shape change has been observed in the ionomers. For example, Table V describes the comparison between Ionomer5 without a bisamide additive and Ionomer5 with a 5 wt % EBS additive. The results, shown in Table V, indicate that the dimensional stability of the Ionomer5 is improved by adding an EBS additive to the ionomer.

Overall, a bisamide additive having a long-saturated alkyl chain, when used with an ionomer, provides the ionomers with a significant improvement in VICAT, creep resistance and dimensional stability at elevated temperature, while maintaining the ionomers' transparency and haze properties.

### CONCLUSIONS

In the present invention, it has been unexpectedly found that by blending long alkyl chain bisamide additives into ionomers, properties of the ionomers such as VICAT softening point, dimensional stability at 60° C. and creep resistance at 70° C. are improved while at an appropriate loading (e.g., 5 wt %), other properties of the ionomers such as transparency are retained. When monoamides, bisamides or di-acids are incorporated into the ionomers, bisamides (e.g., EBS) indicate an improvement in heat resistance performance of the ionomer while the transparency property of the ionomer is maintained. Use of monoamide (e.g. stearamide or behenamide) additives with an ionomer indicates little or even negative impact on the VICAT although the transparency property may be retained. Di-acid additives in ionomers are not compatible with the ionomers and the use of di-acid additives in ionomers results in the ionomers exhibiting poor transparency or haze performance.

When an appropriate amount of EBS (e.g., 5 wt % of EBS) is used in several ionomers with different acids, neutralization ratios and cation types, all of the ionomers demonstrate a significant improvement on VICAT softening point and maintain a similar transparency or haze compared to a control ionomer. Also, some ionomers of the present invention, when compared to a control ionomer, the present invention ionomers (with 5 wt % EBS) demonstrate a significant improvement in both creep resistance and dimensional stability of the ionomer at elevated temperatures.

What is claimed is:

1. A molded article having improved heat resistance, the molded article manufactured from a blend comprising:
(a) greater than or equal to 90 percent by weight of at least one partially neutralized ethylene (meth)acrylic acid copolymer; wherein the acid content of the partially neutralized ethylene (meth)acrylic acid copolymer is from 5 weight percent acid to 30 weight percent acid; and
(b) greater than or equal to 1 percent by weight of at least one bisamide having the following general chemical structure: 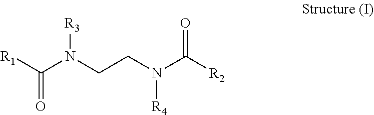
wherein R₁ and R₂ are independently selected from saturated alkyl groups having from C1 to C30 carbon atoms;
wherein R₃ and R₄ are independently selected from hydrogen or an alkyl group having from C1 to C4 carbon atoms;
wherein the molded article exhibits a percent improvement in VICAT softening point, as compared to a partially neutralized ethylene (meth)acrylic acid copolymer without a bisamide additive, of at least 3 percent, and
wherein the molded article exhibits a percent difference in haze, as compared to a partially neutralized ethylene (meth)acrylic acid copolymer without a bisamide additive, of less than or equal to 15 percent.

2. The molded article of claim 1, wherein the neutralization level of the partially neutralized ethylene (meth)acrylic acid copolymer is greater than or equal to 10 percent by weight.

3. The molded article of claim 1, wherein the partially neutralized ethylene (meth)acrylic acid copolymer is an ethylene methacrylic acid, an ethylene acrylic acid, and mixtures thereof.

4. The molded article of claim 1, wherein the concentration of the partially neutralized ethylene (meth)acrylic acid copolymer is from 90 percent to 99 percent.

5. The molded article of claim 1, wherein the bisamide is ethylenebisstearamide, ethylenebislauramide, ethylenebisbehenamide, ethylenebisdecoylamide, ethylenebispelargonamide, ethylenebiscapramide, ethylenebisundecanoic amide, and mixtures thereof.

6. The molded article of claim 1, wherein the concentration of the bisamide is from 1 percent to 10 percent by weight.

7. The molded article of claim 1, wherein the partially neutralized ethylene (meth)acrylic acid copolymer is nominally neutralized with a salt containing alkali metal cations, alkaline earth metal cations, transition metal cations, rare earth metal cations, or combinations of two or more thereof.

8. The molded article of claim 8, wherein the neutralization ratio of the partially neutralized ethylene (meth)acrylic acid copolymer is from 10 percent to 90 percent.

9. A process for manufacturing a molded article having improved heat resistance, comprising the steps of:
(I) weighing the following components to form a blend or mixture:
(a) greater than or equal to 90 percent by weight of at least one partially neutralized ethylene (meth)acrylic acid copolymer; wherein the acid content of the partially neutralized ethylene (meth)acrylic acid copolymer is from 5 weight percent acid to 30 weight percent acid; and
(b) greater than or equal to 1 percent by weight of at least one bisamide having the following structure: 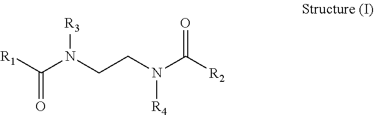
wherein R₁ and R₂ are independently selected from saturated alkyl groups having from C1 to C30 carbon atoms; and
wherein R₃ and R₄ are independently selected from hydrogen or an alkyl group having from C1 to C4 carbon atoms;
(II) melt-mixing or melt-compounding the components of step (I) at a predetermined temperature and for a predetermined period of time to form a mixture composition; and
(III) molding the resultant mixture composition from step (II) into a molded shape through compression molding or injection molding.

10. The process of claim 9, wherein the neutralization level of the at least one partially neutralized ethylene (meth)acrylic acid copolymer is greater than or equal to 10 percent by weight.

11. The process of claim 9, wherein step (II) of forming the mixture composition comprises extruding the partially neutralized ethylene (meth)acrylic acid copolymer and the bisamide from step (I) into a shape of a finished part or article.

12. The process of claim 9, wherein step (II) comprises melt-mixing or melt-compounding the components of step (I) at a predetermined temperature and for a predetermined period of time to form a masterbatch composition; and wherein step (III) comprises molding the resultant masterbatch from step (II) into a molded shape through compression molding or injection molding.

13. The process of claim 9, wherein step (II) of melt-mixing or melt-compounding the components of step (I) is carried out using mixing or compounding equipment selected from the group consisting of a roll mill, an internal mixer, a single-screw extruder, a twin-screw compounding extruder, and a combination thereof.

14. A process for producing a molded article having improved heat resistance comprising forming a composition by blending:
(a) greater than or equal to 90 percent by weight of a partially neutralized ethylene (meth)acrylic acid copolymer; wherein the acid content of the partially neutralized ethylene (meth)acrylic acid copolymer is from 5 weight percent acid to 30 weight percent acid; and
(b) greater than or equal to 1 percent by weight of a bisamide having the following structure: 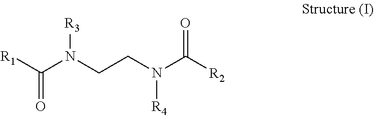
wherein R₁ and R₂ are independently selected from saturated alkyl groups having from C1 to C30 carbon atoms;
wherein R₃ and R₄ are independently selected from hydrogen or an alkyl group having from C1 to C4 carbon atoms; and
wherein the molded article exhibits a percent improvement in VICAT softening point, as compared to a partially neutralized ethylene (meth)acrylic acid copolymer without additives, of at least 3 percent; and
wherein the molded article exhibits a percent difference in Haze, as compared to a partially neutralized ethylene (meth)acrylic acid copolymer without additives, of less than or equal to 15 percent.

15. The process of claim 14, wherein the neutralization level of the partially neutralized ethylene (meth)acrylic acid copolymer is greater than or equal to 10 percent by weight.
